(19) United States
(12) Patent Application Publication
(10) Pub. No.: US 2006/0122951 A1
(43) Pub. Date: Jun. 8, 2006

(54) High speed postage metering device and method utilizing a single print head controller with multiple printing modules

(75) Inventors: Lun Chan, New Fairfield, CT (US); Gary S. Jacobson, Norwalk, CT (US); Easwaran Nambudiri, Rye Brook, NY (US); Joseph P. Tokarski, Prospect, CT (US); Jerome E. Jackson, Williamsburg, VA (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/003,836

(22) Filed: Dec. 3, 2004

(51) Int. Cl. G06F 17/00

(52) U.S. Cl. 705/408

(57) ABSTRACT

A high speed mail processing system having multiple printing modules is provided with a single printer controller or portion thereof that is used to control the operation of all of the printing modules. Messages that originate from the control unit of the mail processing system include a header that identifies the intended recipient(s) of the message, and the single printer controller can route the message to the intended recipient(s) based upon the identification included in the header. The printer controller can be separated into different parts for performing different functions related to the printing modules and only a single part of the printer controller can be provided to control respective functions for all of the printing modules in the system. By allowing the multiple printing modules to share a controller, the need for duplicated hardware is software is removed, thereby decreasing both the complexity and cost of the system.

### FIELD OF THE INVENTION

The invention disclosed herein relates generally to mailing systems, and more particularly to high speed mail processing systems that utilize multiple printing modules for printing indicia and other information on mail pieces.

### BACKGROUND OF THE INVENTION

Mail processing systems for preparing mail pieces, e.g., stuffing envelopes, and/or printing postage indicia on envelopes and other forms of mail pieces have long been well known and have enjoyed considerable commercial success. There are many different types of mail processing systems, ranging from relatively small units that handle only one mail piece at a time, to large, multi-functional units that can process thousands of mail pieces per hour in a continuous stream operation. The larger mailing machines often include different modules that automate the processes of producing mail pieces, each of which performs a different task on the mail piece. The mail piece is conveyed downstream utilizing a transport mechanism, such as rollers or a belt, to each of the modules. Such modules could include, for example, a singulating module, i.e., separating a stack of mail pieces such that the mail pieces are conveyed one at a time along the transport path, a moistening/sealing module, i.e., wetting and closing the glued flap of an envelope, a weighing module, and a metering module, i.e., applying evidence of postage to the mail piece. The exact configuration of the mailing machine is, of course, particular to the needs of the user.

Typically, a control device, such as, for example, a microprocessor, performs user interface and controller functions for the mail processing system. Specifically, the control device provides all user interfaces, executes control of the mail processing system and print operations, calculates postage for debit based upon rate tables, provides the conduit for the Postal Security Device (PSD) to transfer postage indicia to the printer, operates with peripherals for accounting, printing and weighing, and conducts communications with a data center for postage funds refill, software download, rates download, and market-oriented data capture. The control device, in conjunction with an embedded PSD, constitutes the system meter that satisfies U.S. information-based indicia postage meter requirements and other international postal regulations regarding closed system meters.

Modern mail processing systems utilize digital printing techniques for producing images on a mail piece. Conventional digital printing techniques include bubble jet and ink jet, each of which produces an image in a dot matrix pattern. With digital printing, individual print head elements (such as resistors or piezoelectric elements) are selectively electronically stimulated to expel drops of ink from a reservoir onto a substrate, e.g., a mail piece. In either case, by controlling the timing of energizing of the individual print head elements in conjunction with the relative movement between the print head and the mail piece, a dot matrix pattern is produced in the visual form of the desired image. In the case of mail processing systems, the image may be, for example, an indicium that evidences payment of postage.

Digital printing technology has significant advantages when used in a mail processing system as compared to older technology that utilized either a flat platen or a rotary drum to imprint information, such as, for example, address information or an indicium, on mail pieces. For example, if some variable image data needs to be changed, it can easily be done through the installation of new or upgraded software versus having to replace the entire printing module, since the flat platen and drum are typically not separately removable. Moreover, greater printing speeds can be obtained as compared to conventional mechanical printing systems.

The use of a digital printing technology in mail processing systems, however, presents other issues that must be taken into consideration. For example, standard ink jet print heads must be stopped occasionally in order to perform maintenance routines. In particular, “drop-on-demand” style ink jet print heads are known to require periodic maintenance. Maintenance may include a “print head wipe” that occurs approximately every 500 prints, and has a duration of approximately 3 seconds. Maintenance also may include a “print head purge” that occurs after approximately every 3000 prints, and has a duration of approximately 14 seconds. Such maintenance requires the printing module to be inactive, i.e., not perform any print operations, for the period of time required to perform the maintenance. In high speed mail processing systems that can process mail pieces at rates up to 22,000 mail pieces per hour, it is necessary to stop the system completely to allow these maintenance periods to occur. Because of the high volume of mail pieces processed, even very short periods of down-time for maintenance can significantly impact the throughput of the system. For example, halting a system that typically processes 22,000 pieces per hour for only two minutes will reduce the throughput by 733 pieces per hour. If the maintenance is required to be performed at least once per hour, in an eight hour day the throughput of the machine will be decreased by almost 6,000 pieces. To minimize any down-time of the system, it is known to place two print heads or modules (collectively referred to hereinafter as print or printing modules) in series along the transport path, where only one of the printing modules is activated at a time. Thus, when one of the printing modules requires maintenance operations, it can be inactivated and the other printing module activated to print on the mail pieces. For example, if the first printing module requires maintenance, the first printing module is inactivated and the second printing module is activated. Mail pieces will pass through the first printing module, without being imprinted upon, to the second printing module, where printing will occur. When the second printing module requires maintenance, the second printing module is inactivated and the first printing module is activated. Mail pieces will be imprinted upon by the first printing module and will pass through the second printing module without being imprinted with any information.

The use of multiple printing modules in series, while alleviating the problem of reduced throughput, introduces new issues for the mail processing system. For example, to communicate with each of the printing modules, it is necessary to provide electrical switches to switch between each of the printing modules. In addition, each printing module requires its own separate printer controller to control operation of the print head. Each printing module having its own printer controller requires the duplication of both hardware and software that constitute the printer controller, which along with the switching mechanism required add significantly to the complexity and cost of the high speed mail processing system.

Thus, there exists a need for a high speed mail processing system that utilizes multiple printing modules without adding to the complexity, cost or size of the system while still maintaining full functionality required for printing.

### SUMMARY OF THE INVENTION

The present invention alleviates the problems associated with the prior art and provides methods and systems for utilizing a single printer controller, or portions thereof, in conjunction with multiple print heads, thereby not adding complexity, cost or size to the system, while still maintaining the full functionality required for printing.

In accordance with embodiments of the present invention, a high speed mail processing system having multiple printing modules is provided with a single printer controller or portion thereof that is used to control the operation of all of the printing modules. Messages that originate from the control unit of the mail processing system include a header that identifies the intended recipient(s) of the message, and the single printer controller can route the message to the intended recipient(s) based upon the identification included in the header. Optionally, the message could be broadcast to all of the printing modules and only the printing module for which the message is intended will act upon the message.

According to other embodiments, the printer controller can be separated into different parts for performing different functions related to the printing modules, including for example, data management functions and maintenance functions, and only a single part of the printer controller is provided to control respective functions for all of the printing modules in the system. By allowing the multiple printing modules to share a controller, the need for duplicated hardware and software is removed, thereby decreasing both the complexity and cost of the system.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate a presently preferred embodiment of the invention, and together with the general description given above and the detailed description given below, serve to explain the principles of the invention. As shown throughout the drawings, like reference numerals designate like or corresponding parts.

FIG. 1 illustrates in block diagram form a portion of a mail processing system according to an embodiment of the present invention;

FIG. 2 illustrates in block diagram form a portion of a mail processing system according to another embodiment of the present invention;

FIG. 3 illustrates in block diagram form a portion of a mail processing system according to another embodiment of the present invention; and

FIG. 4 illustrates in block diagram form a portion of a mail processing system according to another embodiment of the present invention.

### DETAILED DESCRIPTION OF THE PRESENT INVENTION

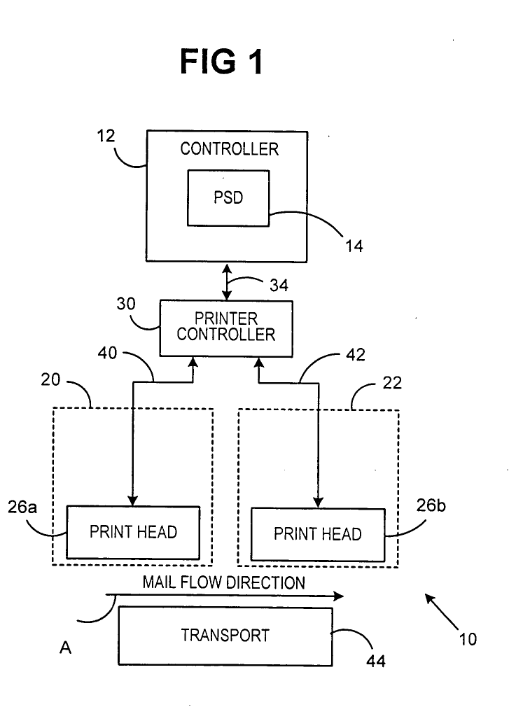

In describing the present invention, reference is made to the drawings, wherein there is seen in FIG. 1 a portion of a mail processing system 10 according to an embodiment of the present invention. It should be noted that while the following description is being made with respect to a mail processing system, the present invention is not so limited and can be utilized in any type of document printing system. System 10 includes a control unit, referred to herein as controller 12, that preferably includes one or more controller units, such as, for example, a microprocessor, general or special purpose processor or the like, to control operation of the mail processing system 10. Specifically, the controller 12, in conjunction with one or more other processors or controllers (not shown), provides all user interfaces, executes control of the mail processing system 10, calculates postage for debit based upon rate tables, provides the conduit for an associated Postal Security Device (PSD) 14 to transfer postage indicia for printing, operates with peripherals for accounting, printing and weighing, and conducts communications with a data center for postage funds refill, software download, rates download, and market-oriented data capture. The PSD 14, which is preferably embedded in the controller 12, contains one or more registers that store the accounting information concerning usage, such as, for example, an ascending register, descending register, piece count register, and the like. The controller 12, in conjunction with the embedded PSD 14, provides the system meter that satisfies U.S. and international postal regulations regarding closed system information-based indicia postage (IBIP) meters.

Mail processing system 10 further includes two printing modules: an upstream printing module 20 and a downstream printing module 22. It should be understood that while the description below is made with respect to two printing modules 20, 22, the present invention is not so limited and more than two printing modules may be provided. The printing modules 20, 22 preferably utilize digital printing technology, and include a respective print head 26a, 26b. According to an embodiment of the present invention, the printing modules 20, 22 are controlled by a single printer controller 30, instead of each printing module 20, 22 being provided with its own printer controller as done in the prior art, thereby deceasing both the complexity and cost of the system 10. The printer controller 30 is coupled to the controller 12. The printer controller 30 controls all operations of printing modules 20, 22 related to management of data from the controller 12 and maintenance of each print head 26a, 26b. Management of the data can include, for example, the decryption (if encrypted when received from the controller 12), grouping, formatting and distribution of data between groups of ink jets in the appropriate print head 26a, 26b, generation of the timing signals necessary for firing the ink jets of the appropriate print head 26a, 26b, collection of usage information of the print heads 26a, 26b, and detection of overheating conditions in the print heads 26a, 26b. Maintenance functions could include, for example, controlling positioning of the print heads 26a, 26b to ensure the print heads 26a, 26b are in a capped position when not printing, ensuring the print heads 26a, 26b are capped properly when in the capped position, ensuring ink is present in either the ink reservoir(s) (not shown) or the print heads 26a, 26b, ensuring ink is being properly supplied from the reservoir(s), monitoring the voltages being applied to fire the ink jets of the print heads 26a, 26b, and monitoring for error conditions during operation including improper positioning of the print heads 26a, 26b, overheating of the print heads 26a, 26b, out of ink conditions, etc.

Data and control signals from the controller 12 are transmitted to the printer controller 30 via data line 34. Data and control signals are transmitted to the printing modules 20, 22 via data lines 40, 42 respectively. A transport 44, including, for example, rollers and/or belts, is utilized to transport mail pieces along a transport path through the mail processing system 10 in the direction indicated by arrow A. The printing modules 20, 22 are arranged serially along the transport path. The transport 44 will transport the mail pieces past the printing modules 20, 22 such that printing by one of the printing modules 20, 22 can occur on each mail piece. Sensors (not shown) located along the transport 44 provide signals to the controller 12 to indicate the position of a mail piece on the transport 44. Only one of the printing modules 20, 22 is activated at a time. For example, if the printing module 20 is currently deactivated, mail pieces will pass through the printing module 20, without being imprinted upon, to the printing module 22, where printing will occur. When the printing module 22 is made inactive, such as, for example, when maintenance is necessary, the printing module 20 is activated. Mail pieces will be imprinted upon by the printing module 20 and will pass through the printing module 22 without being imprinted with any information.

Alternatively, the printing modules 20, 22 can be arranged in a parallel fashion and mail pieces diverted to the printing module that is currently activated. When the currently active print module requires maintenance, it can be deactivated, the other print module activated, and the mail pieces diverted along the transport path to pass under the currently active printing module.

Since the printer controller 30 of the present invention is utilized to control both printing modules 20, 22, it is necessary to distinguish the intended recipient, i.e., either print head 26a or print head 26b, of messages, e.g., print messages and commands, from controller 12. This will ensure that messages intended for the printing module 20 and print head 26a are not improperly acted upon by the printing module 22 and print head 26b. To achieve this, each of the print heads 26a, 26b is provided with a unique identification number, and every message provided from the controller 12 to the printer controller 30 includes a header that specifies the identification number of the print head 26a, 26b for which the message is intended. The identification number may be, for example, a serial number or the like, or an address of the print heads 26a, 26b. Based upon the identification of the intended print head 26a or 26b in the message from the controller 12, the printer controller 30 will act upon and route the message to the proper print head 26a or 26b using either data line 40 or 42, respectively. Optionally, a predetermined fixed value for the header could be used to signify that a message from the controller 12 is a broadcast message intended for every print head in the system 10. In this situation, the printer controller 30, upon determining that the message is a broadcast message intended for all print heads in the system 10, will act upon and route the message to all print heads in the system 10. Thus, each print head in the system 10 will receive commands from the printer controller 30 and respond accordingly based on the message from the controller 12. The use of broadcast messages allows optimization of the time needed to complete various operations that need to be performed in preparation for printing. This time optimization is achieved by each of the printing modules being prepared to print prior to a print command, and therefore can execute the printing task without any additional preparation time required, thereby reducing the total amount of time required to execute the task.

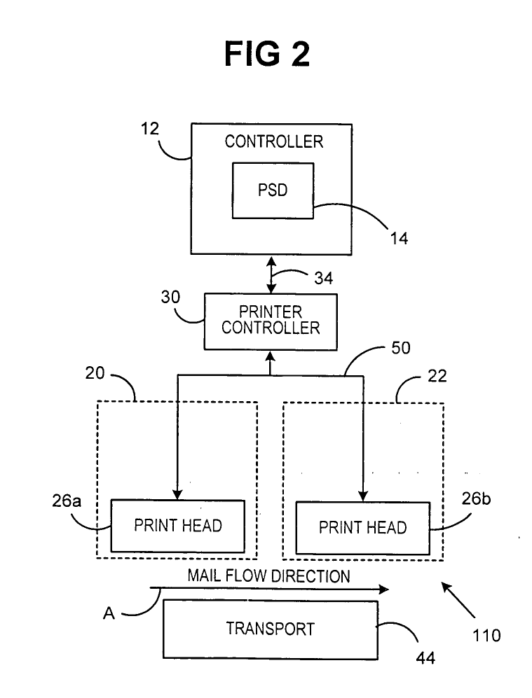

According to an alternative embodiment illustrated in FIG. 2, mail processing system 110 is similar to that of mail processing system 10 of FIG. 1 except that data lines 40, 42 are combined into a single data line 50 that couples each printing module 20, 22 to the printer controller 30. Thus, every message from the controller 12, and/or commands generated by the printer controller 30 based on the message, will be sent from the printer controller 30 to each printing module 20, 22 via the data line 50. The print heads 26a, 26b will check the header in each message/command and only act upon those messages/commands that are intended for each specific print head 26a, 26b. Thus, for example, if a message header identifies that the message is intended only for print head 26a, then only print head 26a will respond to the message, e.g., perform the operation required, and the print head 26b will ignore the message. If the message is intended for all printing modules in the system 10, then both of the print heads 26a, 26b will respond to the message. Examples of such events when a message is intended for all printing modules include during initial operations upon power-up, final operations for a power down, or recovery to a home position in response to a jam condition.

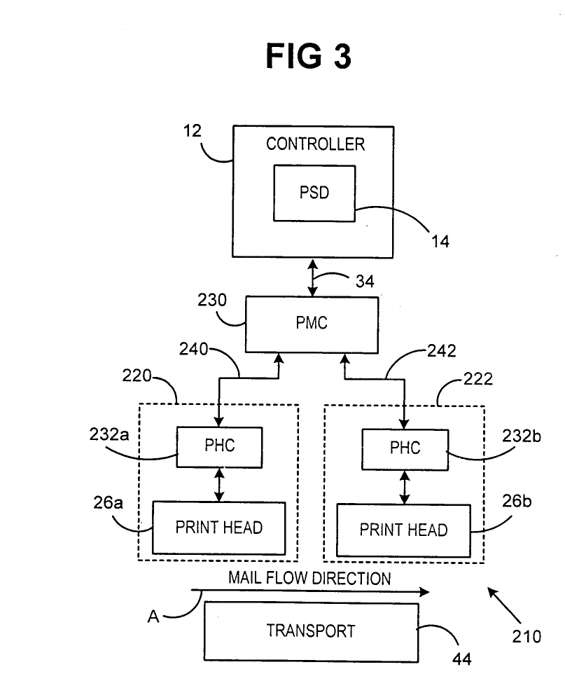

FIG. 3 illustrates a portion of a mail processing system 210 according to another embodiment of the present invention. Mail processing system 210 is similar to mail processing system 10 of FIG. 1 except the printer controller 30 of FIG. 1 is separated into different components based upon the functions performed. Specifically, the printer controller 30 is separated into a single printer maintenance controller (PMC) 230 and multiple print head controllers (PHC) 232a, 232b. Each of the printing modules 220, 222 includes a respective print head 26a, 26b and a respective PHC 232a, 232b. The PMC 230 controls all maintenance operations as previously described that are required to be performed on either of the print heads 26a, 26b. Thus, all maintenance operations required for the printing modules 220, 222 are controlled by a single PMC 230, instead of each printing module 220, 222 being provided with its own PMC as done in the prior art, thereby decreasing the complexity and cost of the system 210. Each PHC 232a, 232b controls and performs all of the data management functions as previously described only for its respective print head 26a, 26b. Messages provided from the controller 12 to the PMC 230 include a header that specifies the identification number of the print head 26a, 26b for which the message is intended. Based upon the identification of the intended print head 26a or 26b in the message from the controller 12, the PMC 230 will act upon and route the message to the proper PHC 232a or 232b using either data line 240 or 242, respectively. Optionally, a predetermined fixed value for the header could be used to signify that a message from the controller 12 is a broadcast message intended for every print head in the system 210. In this situation, the PMC 230, upon determining that the message is a broadcast message intended for all print heads in the system 210, will act upon and route the message to all print heads in the system 210. Thus, each print head in the system 210 will receive and respond accordingly to the routed message.

Optionally, the data lines 240, 242 could be combined into a single data line (similarly as described with respect to FIG. 2) and every message from the controller 12 will be sent through the PMC 230 to each printing module 220, 222. The PHCs 232a, 232b will check the header in each message and only act upon those messages that are intended for its specific print head 26a, 26b. Thus, for example, if a message header identifies that the message is intended only for print head 26a, then only PHC 232a will act upon the message, e.g., perform the operation required, and the PHC 232b will ignore the message. If the message is intended for all printing modules in the system 210, then both PHC 232a and PHC 232b will respond to the message.

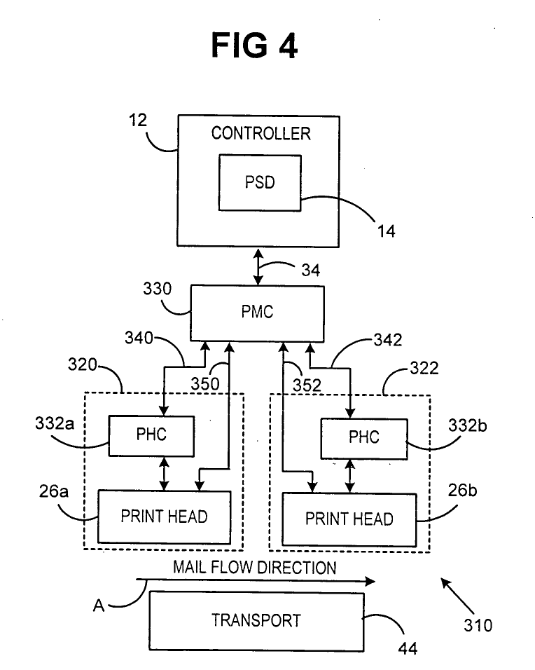

FIG. 4 illustrates a portion of a mail processing system 310 according to another embodiment of the present invention. Mail processing system 310 is similar to mail processing system 10 of FIG. 1 except the printer controller 30 of FIG. 1 is separated into a single print head controller (PHC) 330 and multiple printer maintenance controllers (PMC) 332a, 332b. Each of the printing modules 320, 322 includes a respective print head 26a, 26b and a respective PMC 332a, 332b. The PHC 330 controls and performs all of the data management functions as previously described for both of the print heads 26a, 26b. Thus, all data management operations required for the printing modules 320, 322 are controlled by a single PHC 330, instead of each printing module 320, 322 being provided with its own PHC as done in the prior art, thereby decreasing the complexity and cost of the system 310. Each PMC 332a, 332b controls and performs all of the maintenance functions as previously described only for its respective print head 26a, 26b. Messages provided from the controller 12 to the PHC 330 include a header that specifies the identification number of the print head 26a, 26b for which the message is intended. Based upon the identification of the intended print head 26a or 26b in the message from the controller 12, the PHC 330 will act upon and route the message to the proper print head 26a or 26b, via PMC 332a or 332b, using either data line 340 or 342, respectively. Optionally, a predetermined fixed value for the header could be used to signify that a message from the controller 12 is a broadcast message intended for every print head in the system 310. In this situation, the PHC 330, upon determining that the message is a broadcast message intended for all print heads in the system 310, will route the message to all print heads in the system 310. Thus, each print head in the system 310 will receive and respond accordingly to the routed message.

The above description requires that all messages from the PHC 330 be passed through one or more of the PMCs 332a, 332b via data lines 340, 342. Optionally, the PHC 330 may also be coupled directly to each print head 26a, 26b by data lines 350, 352. Thus, any messages provided from the controller 12 to the PHC 330 that do not require any maintenance operations, and thus do not need a PMC to be performed, can be passed directly to the intended print head 26a or 26b via a respective data line 350, 352 without having to pass through either of the PMCs 332a or 332b.

Optionally, the data lines 340, 342, as well as 350, 352, could be combined into a single data line (similarly as described with respect to FIG. 2) and every message from the controller 12 will be sent through the PHC 330 to each printing module 320, 322. The print heads 26a, 26b and PMCs 332a, 332b will check the header in each message and only act upon those messages that are intended for it. Thus, for example, if a message header identifies that the message is intended only for print head 26a and does not involve a maintenance function, i.e., PMC 332a is not required, then only print head 26a will act upon the message, e.g., perform the operation required, and the PMCs 332a, 332b and print head 26b will ignore the message. If a message is sent indicating that maintenance is to be performed upon one of the print heads 26a, 26b, then the respective PMC 32a or 332b will act upon the message and perform the operation required in the message.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description.

What is claimed is:

1. A document processing system comprising:
a control unit to generate images for printing on documents;
a transport to transport documents along a transport path in the document processing system;
a printer controller coupled to the control unit;
a first printer module coupled to the printer controller, the first printer module being located along the transport path and including a first print head for printing on documents being transported thereon;
a second printer module coupled to the printer controller, the second printer module being located along the transport path and including a second print head for printing on documents being transported thereon;
wherein the printer controller controls at least a portion of operations performed by both the first print head and the second print head.

2. The system of claim 1, wherein messages generated by the control unit include an identification of one of the first and second print heads for which the message is intended, and the printer controller acts upon and routes the message to the intended print head based on the identification included in the message.

3. The system of claim 2, wherein the identification of one of the first and second print heads is included in a header of each message.

4. The system of claim 3, wherein a predetermined header indicates that the message is intended for both of the first and second print heads, and the printer controller acts upon and routes the message to both of the first and second print heads.

5. The system of claim 1, wherein messages generated by the control unit include an identification of one of the first and second print heads for which the message is intended, and the printer controller acts upon and routes the message to both of the first and second print heads, and the first and second print heads will act on the message only if they were the intended recipient of the message based on the identification included in the message.

6. The system of claim 1, wherein the printer controller controls operations related to data management and maintenance for both of the first and second print heads.

7. The system of claim 1, wherein the printer controller controls operations related only to data management for both of the first and second print heads, and each of the first and second printing modules further comprises:
a respective printer maintenance controller to control operations related to maintenance for its respective first and second print head.

8. The system of claim 7, wherein the printer controller is coupled directly to each print head and to each printer maintenance controller.

9. The system of claim 1, wherein the printer controller controls operations related only to maintenance for both of the first and second print heads, and each of the first and second printing modules further comprises:
a respective print head controller to control operations related to data management for its respective first and second print head.

10. The system of claim 1, wherein the control unit further comprises an associated payment security device, the documents are mail pieces and the first and second print heads print indicia generated by the associated payment security device on the mail pieces.

11. The system of claim 1, wherein the first printer module and second printer module are located serially along the transport path, the first printer module being located upstream in the transport path from the second printer module.

12. A method of operating a document processing system having a control unit, a first and second printing module, and a single printer controller to control at least a portion of operations of both the first and second printing modules, the method comprising:
generating a message at the control unit, the message including a command for at least one of the first and second printing modules to perform an operation, the message including an identification of the intended recipient of the message;
sending the message from the control unit to the printer controller;
determining, at the printer controller, the intended recipient of the message based on the identification included in the message; and
controlling, using the printer controller, operation of either of the first and second printing module based on the intended recipient of the message.

13. The method of claim 12, wherein the printer controller controls operations related to data management and maintenance for both of the first and second printing modules.

14. The method of claim 12, wherein the printer controller controls operations related only to data management for both of the first and second printing modules.

15. The method of claim 12, wherein the printer controller controls operations related only to maintenance for both of the first and second printing modules.

16. The method of claim 12, wherein the identification of the intended recipient of the message is a predetermined identification that identifies both the first and second printing modules, and the method further comprises:
determining, at the printer controller, that the intended recipient includes both the first and second printing modules; and
controlling, using the printer controller, operation of both the first and second printing modules according to the message.
